(19) United States
(12) Patent Application Publication
(10) Pub. No.: US 2003/0122384 A1
(43) Pub. Date: Jul. 3, 2003

(54) Rapid-release frangible fastener

(76) Inventors: Roy T. Swanson, LaGrange Park, IL (US); James W. Fargo, Winnetka, IL (US)

Correspondence Address: James V. Lapacek, S & C Electric Co., 6601 N. Ridge Blvd., Chicago, IL, 60626, US

(21) Appl. No.: 10/290,758

(22) Filed: Nov. 12, 2002

Related U.S. Application Data
(60) Provisional application No. 60/340,395, filed on Dec. 18, 2001.

(51) Int. Cl. G09F 3/03

(52) U.S. Cl. 292/307 R

(57) ABSTRACT

A rapid-release frangible fastener is provided that is operative in response to a force in excess of a predetermined value to quickly and reliably release and separate, e.g. for the rapid release of a pressure relief vent in switchgear for electrical power transmission and distribution. In a preferred embodiment, the frangible fastener utilizes a strain wire having a predetermined breaking strength. A resilient member is provided to ensure that the load on the frangible fastener is relatively constant, e.g. in response to vibration or distortion of the parts to which the fastener is connected.

### BACKGROUND OF THE INVENTION

This application claims the benefit of U.S. Provisional Application No. 60/340,395 filed on Dec. 18, 2001 in the names of R. T. Swanson and J. F. Fargo.

1. Field of the Invention

The present invention relates generally to the fields of fasteners and overpressure relief arrangements especially for the rapid release of a pressure relief vent in switchgear for electrical power transmission and distribution and more particularly to a rapid-release frangible fastener that is operative in response to a force in excess of a predetermined value to quickly and reliably release and separate.

2. Description of the Related Art

Various types of frangible fasteners and pressure relief arrangements are known in the prior art. For example, examples of pressure relief arrangements are shown in U.S. Pat. Nos. 4,583,750, 5,100,157 and 5,521,567 and copending application No. 10/017260 filed Dec. 18, 2001 in the names of J. Opfer et al.

While the arrangements of the prior art may be generally suitable for their intended uses, it would be desirable to provide a rapid-release frangible fastener.

### SUMMARY OF THE INVENTION

Accordingly, it is a principal object of the present invention to provide a rapid-release frangible fastener that is operative in response to a force in excess of a predetermined value to quickly and reliably release and separate, e.g. for the rapid release of a pressure relief vent in switchgear for electrical power transmission and distribution.

This and other objects of the present invention are efficiently achieved by a rapid-release frangible fastener that is operative in response to a force in excess of a predetermined value to quickly and reliably release and separate, e.g. for the rapid release of a pressure relief vent in switchgear for electrical power transmission and distribution. In a preferred embodiment, the frangible fastener utilizes a strain wire having a predetermined breaking strength. A resilient member is provided to ensure that the load on the frangible fastener is relatively constant, e.g. in response to vibration or distortion of the parts to which the fastener is connected.

### BRIEF DESCRIPTION OF THE DRAWING

The invention, both as to its organization and method of operation, together with further objects and advantages thereof, will best be understood by reference to the specification taken in conjunction with the accompanying drawing in which:

FIG. 1 is a sectional view of a frangible fastener according to the present invention;

FIG. 2 is an elevational view of a first assembly of the frangible fastener of FIG. 1;

FIG. 3 is a sectional view taken generally along the line 3-3 of FIG. 2;

FIG. 4 is an elevational view of a strain wire assembly of the frangible fastener of FIG. 1;

FIG. 5 is a perspective view of the frangible fastener of FIG. 1 illustrating an application for the rapid release of a pressure relief vent in switchgear for electrical power transmission and distribution;

FIG. 6. Is an elevational view of a first tool for adjusting the frangible fastener of FIG. 1 to provide a predetermined holding force;

FIG. 7 is a sectional view taken generally along the line 7-7 of FIG, 6; and

FIG. 8 is a sectional view of a second tool for adjusting the frangible fastener of FIG. 1.

### DETAILED DESCRIPTION

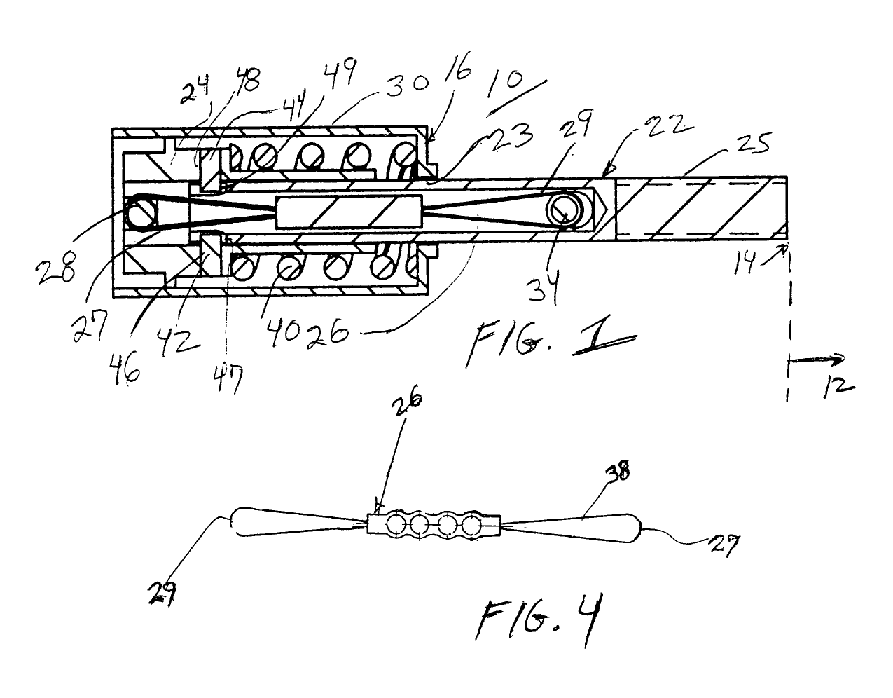

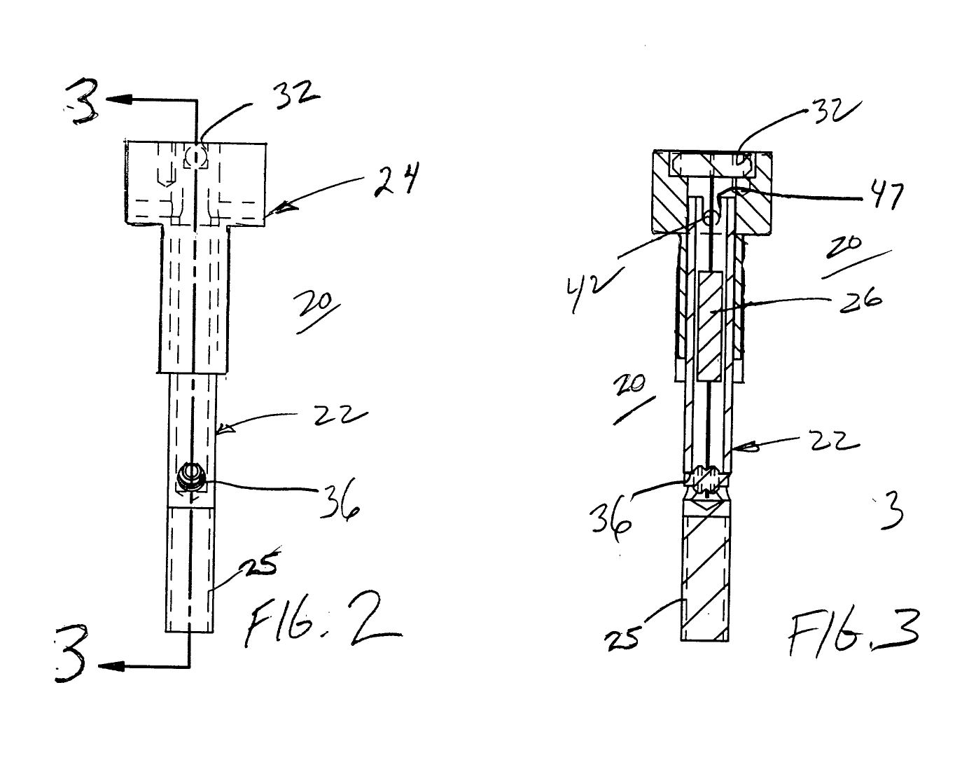

Referring now to FIGS. 1-4, a frangible fastener 10 of the present invention is illustrated that is operative in response to a force in excess of a predetermined value, e.g. responsive to a force at 12 applied at a first point 14 of the frangible fastener 10 with respect to a second point at 16 of the frangible fastener. The frangible fastener 10 includes a first assembly 20 as shown in FIGS. 2 and 3 that is slidably disposed within a sleeve 30. A spring 40 is disposed so as to act between the first assembly 20 and the sleeve 30. The first assembly 20 includes two relatively movable members 22 and 24 with the member 22 being slidably received within a bore 23 of the member 24. The first assembly 20 also includes a strain element 26 that is attached between the two members 22 and 24 as will be explained in more detail hereinafter to restrain their separation in a direction that would elongate the strain wire 26, i.e. the strain element 26 acts as a control facility to prevent the two members 22 and 24 from separating until the predetermined force is exceeded in the direction of separation.

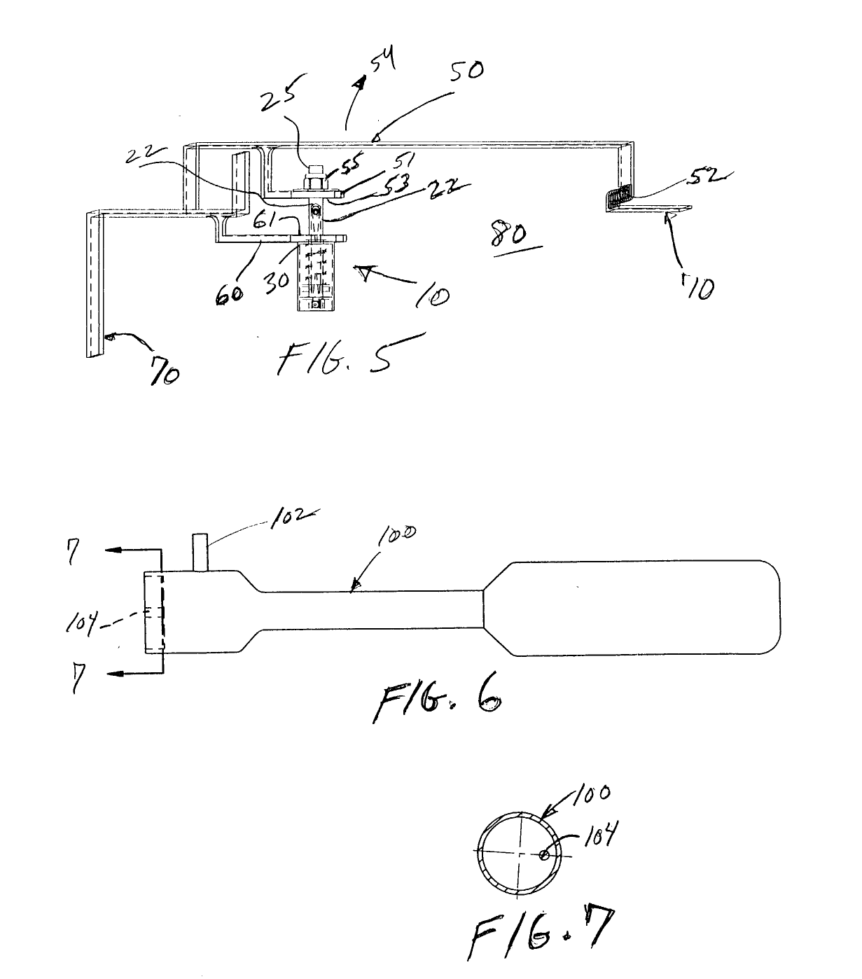

With the first assembly 20 and the sleeve 30 arranged in an operative position as shown in FIG. 5 so as to compress the spring 40, a predetermined restraining force is applied to restrain the relative movement between the components 20 and 30. For example, as shown in FIG. 5, the frangible fastener 10 is installed in operative position between a vent 50 and a housing portion 60 of switchgear housing 70, the vent 50 being hinged at 52 with respect to the switchgear housing 70. The first point 14 of the frangible fastener 10 is retained by the vent 50 and the second point 16 of the frangible fastener 10 is retained by the housing portion 60. Accordingly, when the pressure at 80 within the switchgear housing 70 exceeds a predetermined value, the forces on the vent 50 overcome the spring 40 and apply force to separate the two end points 14, 16 sufficient to break the strain element 26 whereupon the members 22, 24 move apart from each other releasing the vent 50 for opening in direction 54 to relieve the overpressure and vent the interior 80 of the switchgear housing 70.

Referring now to FIGS. 1-4 and 8, the strain element 26 is retained at first end 27 within the member 24 via a pin 28 (FIG. 1) that fits within a slotted or recessed portion 32 (FIG. 3) of the member 24. Further, the strain element 26 is retained at a second end 29 within the member 22 via a pin 34 (FIG. 1) that fits within a bore 36 (FIG. 2) formed through the member 22. As shown in FIG. 4, the strain element 26 in the illustrative embodiment is fabricated as a looped wire 38 retained within a central ferrule element 39. The member 22 is retained within the member 24 against relative movement in both the radial and axial directions via two pins 42, 44 (FIG. 1) that are inserted through respective passages 46, 48 formed through the member 24 and extending into open slotted portions 47, 49 of the member 22.

As shown in FIG. 5, in the illustrative application, the frangible fastener 10 is installed between an attachment member 51 extending from the inner side of the vent 50 and the housing portion 60, e.g. the member 22 is installed through a hole 61 in the attachment member 60 and a hole 53 of the attachment member 51, a nut 55 is threaded unto a threaded portion 25 of the member 22 that extends through the hole 53 of the attachment member 51, and the collar 30 acts against the attachment member 60 to retain the other end of the frangible fastener 10.

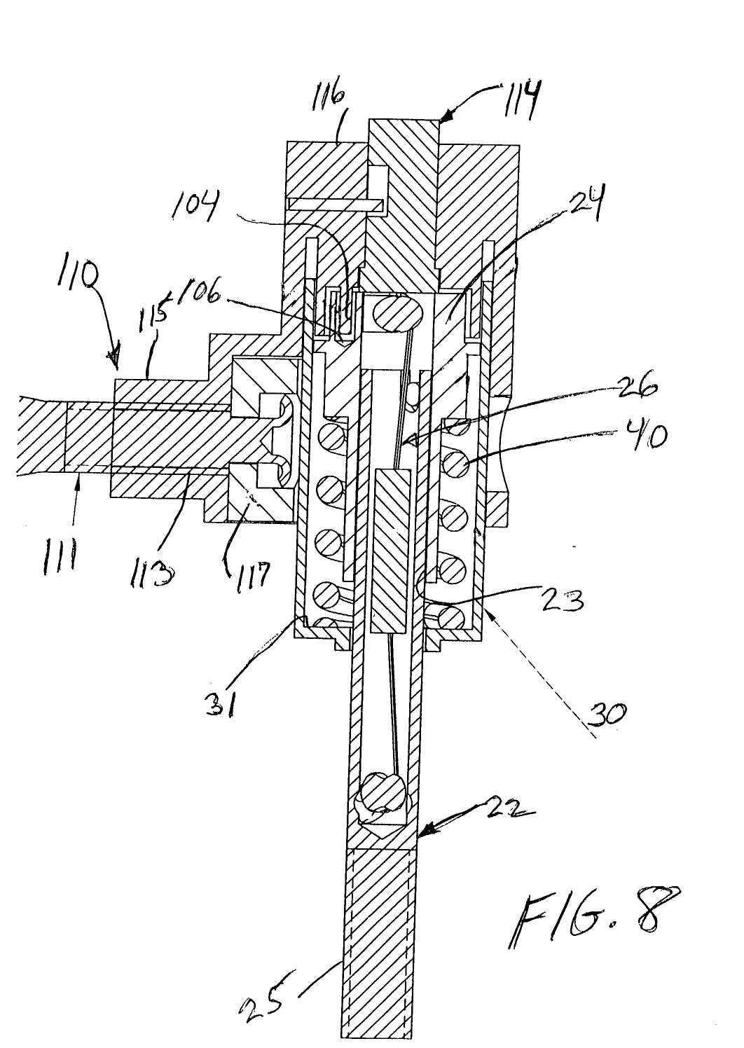

Referring now additionally to FIGS. 6 and 7, a tool 100 is provided to tighten and apply a desirable pretension to the frangible fastener 10 after the installation of the frangible fastener 10. This pretension ensures that the vent 50 remains closed until the predetermined pressure is exceeded, i.e. pressures lower than the predetermined pressure do not partially open the vent 50 even on a temporary or transient basis either due to internal pressure or wind outside the switchgear housing 70. The tool 100 functions as a wrench and includes a pointer 102 to facilitate counting the number of turns the frangible fastener 10 is rotated relative to the nut 55 and a locating pin 104 that that cooperates with a receiving socket 106 (FIG. 8) in the member 24 to accomplish rotation of the member 24 via rotation of the tool 100.

In FIG. 8, there is illustrated another tool 110 that includes provisions and facilities to grasp the collar 30 so as to establish the relative position of the member 24 to the collar 30 when the spring 40 is contacting both the member 24 and the collar 30 at base shoulder 31. The tool 110 is clamped to the frangible fastener 10 via the rotation of a threaded handle portion 111 within a mating threaded portion 113 of a body portion 115 of the tool 110, the handle portion 111 acting against a clamp bar 117 of the tool 110. The tool 110 includes the wrench pin 104 as in the tool 100 and a flush pin gauge assembly generally referred to at 112 to accomplish the desired function. Specifically, the flush pin gauge assembly 112 includes a movable pin member 114 that extends from the flush pin gauge assembly 112. As the tool 110 is rotated, the pin member 114 moves downward in FIG. 8. The geometry of the pin member 114 is arranged so that the pin member 114 is flush or even with the top surface 116 of the flush pin gauge assembly 112 when the appropriate amount of predetermined pretension has been achieved by compressing the spring 40.

The frangible fastener 10 is provided with tamper resistant features via the provision of a self locking nut 55 and the recessed access to the member 24 via the collar 30 extending over the member 24, i.e. such that there is limited access to the collar 30 and the member 24 can not be rotated with pliers or ordinary wrenches etc.

While there has been illustrated and described a preferred embodiment of the present invention, it will be apparent that various changes and modifications will occur to those skilled in the art. Accordingly, it is intended in the appended claims to cover all such changes and modifications that fall within the true spirit and scope of the present invention.

1. A frangible fastener comprising:
first and second separable elements and controlling means for controlling the rapid separation of the first and second elements in response to a predetermined force in the direction of separation, said controlling means including first resilient means acting to apply a force in opposition to the separation of the first and second elements and second yielding means being acted upon through the first resilient means and being responsive to a predetermined force of separation between the first and second elements to rapidly release the first and second elements to permit separation thereof.

2. The frangible fastener of claim 1 wherein the first element includes a first member and a second concentric members, the second element comprising a third member that is received within the first member, the second member being disposed about the first member, the first resilient means comprising a coil spring mounted between the first and second members.

3. The frangible fastener of claim 2 wherein second yielding means comprises a strain wire.

4. The combination of a frangible fastener that includes first and second separable members that are rapidly separated in response to a predetermined force in the direction of separation and a tool for accurately setting a pretension for the frangible fastener representing a force opposite to the direction of separation.
